(19) United States
(12) Patent Application Publication
(10) Pub. No.: US 2015/0164089 A1
(43) Pub. Date: Jun. 18, 2015

(54) CAKE DECORATING SYSTEM

(71) Applicant: Innovative Sugar Works, Seattle, WA (US)

(72) Inventors: Meghan Chancellor Hengesteg Allison, Seattle, WA (US); Christopher Evan Allison, Seattle, WA (US)

(21) Appl. No.: 14/502,634

(22) Filed: Sep. 30, 2014

Related U.S. Application Data
(60) Provisional application No. 61/917,645, filed on Dec. 18, 2013.
(60) Provisional application No. 61/978,216, filed on Apr. 11, 2014.
(60) Provisional application No. 62/014,239, filed on Jun. 19, 2014.

(51) Int. Cl. A21C 15/00; B65D 85/60; B65D 25/28; B65D 81/38; A23G 3/28; A47G 23/08

(52) U.S. Cl. CPC A21C 15/002; A23G 3/28; A47G 23/08; B65D 25/2805; B65D 81/3813; B65D 85/60

(57) ABSTRACT

A cake decorating and transportation system includes, but is not limited to, shaping tools for the application and/or manipulation of a sugar-based substance, a turntable having a working surface and handles, and a container or vessel configured to preserve and transport a finished product. The components of the system may be employed in combination or may be employed independently to produce the product and then transport it to a final destination. The vessel configured to cooperate with the turntable.

### PRIORITY CLAIM

The present application claims the benefit of the earliest effective filing dates of U.S. Provisional Patent Application No. 61/917,645 (filed on Dec. 18, 2013); 61/987,216 (filed on May 1, 2014); and 62/014,239 (filed on Jun. 19, 2014), wherein the contents of each of these applications are incorporated herein by reference in their entireties.

### FIELD OF THE INVENTION

The present invention generally relates to systems and sub-systems for decorating, supporting, and transporting a baked product, such as a wedding cake.

### BACKGROUND

Cake decorating has long been regarded as a form of artistry in which an artisan uses a sugar-based substance to make the cake more aesthetically appealing for its intended purpose. Cakes may be molded and sculpted to resemble three-dimensional persons, places and things. Cakes are often decorated to mark a special celebration such as, but not limited to, a birthday or wedding. They can also mark national or religious holidays, or be used to promote commercial enterprises. In other words, cakes may be baked and decorated for almost any purpose or occasion.

Conventional cake decorating generally involves covering the baked cake or product with a sugar-based substance (e.g., frosting or icing) and then using decorative sugar, sugar dough, candy, chocolate, modeling chocolate, or icing decorations to further embellish the cake.

Cake decorating has become a form of unique artistry. The artisan's imagination can create anything from a single layered cake to a multi-tiered or multi-layered three-dimensional creation decorated with edible coatings and candies.

In the 1700's, women in Europe started using special cake pans to create flour based cakes. It became popular to see who could serve the most ornate and unique cakes, pastries or other baked products.

In the mid 1800's, the temperature controlled oven revolutionized the art of baking. Cake decorating became almost a sport. Having the most elaborately decorated or unique cake at a social function was crucial to anyone who wanted to acquire social standing.

### SUMMARY

In one embodiment, the present invention generally relates to a system that includes, but is not limited to, shaping tools for the application and/or manipulation of sugar, chocolate, modeling chocolate, marzipan, gum/sugar paste and fondant, a turntable that provides a larger support surface and a more effective work surface, and a container or vessel configured to preserve and transport a delicate product. The components of the system may be employed in combination or may be employed independently to produce the product and then transport it to a final destination.

In one aspect of the present invention, a system for a baked product includes a shaping tool made from a food-grade material, the shaping tool having a main body with flexible tips coupled to the body, the flexible tips configured to manipulate a sugar-based substance in a desired manner; a turntable having a working surface area that is substantially larger than a contact area of the baked product, the turntable having an upper surface configured to minimize lateral movement of the baked product, the turntable having at least one sidewall with handles; and a transportation system having a vessel sized to receive the baked product

In another aspect of the present invention, a system for a baked product includes a shaping tool made from a food-grade material, the shaping tool having a main body with flexible tips coupled to the body, the flexible tips configured to manipulate a sugar-based substance in a desired manner; a turntable having a working surface area that is substantially larger than a contact area of the baked product, the turntable having an upper surface configured to minimize lateral movement of the baked product, the turntable having at least one sidewall with handles; and a transportation system having at least two parts connectable to each other, each part having a shoulder to support the turntable when the parts are connected.

In yet another aspect of the present invention, a turntable for supporting a baked product includes an upper working surface having a working surface area that is substantially larger than a contact area of the baked product; a sidewall extending from the upper working surface; a plurality of recessed handles formed in the sidewall; a bottom surface; and a plurality of structural ribs extending downward from the bottom surface of the turntable.

### BRIEF DESCRIPTION OF THE DRAWINGS

In the drawings, identical reference numbers identify similar elements or acts. The sizes and relative positions of elements in the drawings may not be necessarily drawn to scale. For example, the shapes of various elements and angles may not be drawn to scale, and some of these elements may be arbitrarily enlarged or positioned to improve drawing legibility.

FIG. 1 is a plan view of a plurality of shaping tools according to an embodiment of the present invention;

FIG. 2 is a perspective view of a turntable system according to an embodiment of the present invention;

FIG. 3 is a top (upper-side) perspective view of a turntable expander according to an embodiment of the present invention;

FIG. 4 is a bottom (under-side) perspective view of the turntable expander of FIG. 3;

FIG. 5 is a front, elevational view of a product transportation system holding a baked product according to an embodiment of the present invention;

FIG. 6 is a perspective view of the product transportation system of FIG. 5 according to an embodiment of the present invention;

FIG. 7 is a top, plan view of the product transportation system of FIG. 6 in a disassembled configuration according to an embodiment of the present invention;

FIG. 8 is a perspective view of product transportation system according to another embodiment of the present invention; and

FIG. 9 is an exploded, perspective view of the product transportation system of FIG. 8.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with systems and methods for preparing, processing, decorating, manipulating and transporting decorated cakes may have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, which is as “including, but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the claimed invention

An embodiment of the present invention is generally directed toward a cake decorating system that includes, but is not limited to, shaping tools for the application and/or manipulation of sugar, chocolate, modeling chocolate, marzipan, gum/sugar paste, and fondant, a turntable that provides a larger support surface for cake tiers and provides a more effective work surface, and a container or vessel configured to preserve and transport a decorated cake. These different aspects of the present embodiment may be employed in combination or may be employed independently to produce the decorated cake and transport to its final destination.

For purposes of brevity and clarity, the embodiments of the invention discussed herein are directed to decorated, baked cakes, however these embodiments are also applicable to other products such as, but not limited to, other baked goods (e.g., pastries), culinary food products, sugar sculptures, chocolate displays, art projects, plating, etc. The phrase “decorated cake” as used herein should be broadly interpreted as any type of cake that can be baked, decorated and produced to a customer or other recipient. By way of example, the decorated cake may take the form or a wedding cake, an anniversary cake, a birthday cake, or a cake for any event in which a customer may want the cake professional produced, decorated, and transported to an event destination.

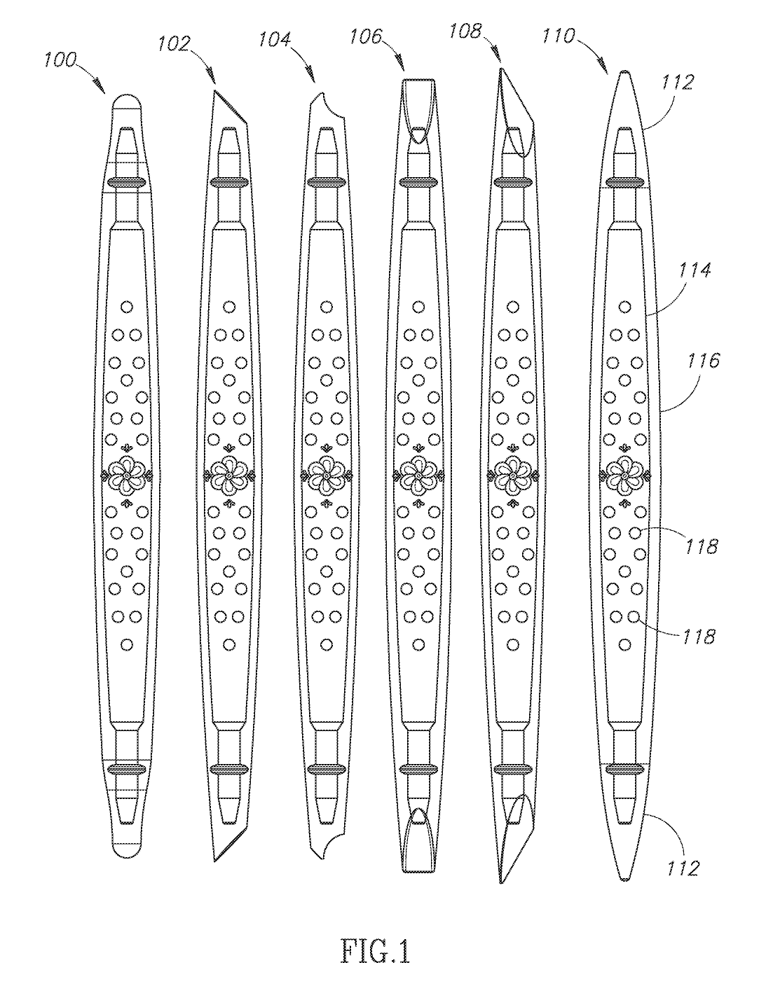

FIG. 1 shows a plurality of shaping tools 100, 102, 104, 106, 108 and 110, respectively (also referred to herein as applicators) for the application and manipulation of sugar-based substances such as, but not limited to, the application and manipulation of frosting, sugar, chocolate, modeling chocolate, marzipan, gum/sugar paste and fondant and to blend, apply texture, emboss, tuck edges and smooth. In the illustrated embodiment, the shaping tools are configured for cake decorating or pastry decorating. The shaping tools may be used in commercial establishments such as, but not limited to, professional kitchens and bakeries as well as residential establishments for home and hobby bakers.

The following description is applicable to all of the shaping tools in FIG. 1, but for purposes of brevity the description is focused on shaping tool 110. The shaping tool 110 includes flexible tips 112 that allow the sugar-based substance to be moved gently without undesirably cutting or scoring the cake. In one embodiment, the tips 112 are made from a thermoplastic elastomer (TPE), silicon, or some other type of polymeric material having an appropriate durometer for a selected application. Preferably, the tips 112 are made from a resilient, food-grade silicone having a generally three-dimensional working surface. Based on the material and durometer of the tips 112, the tips may operate to form an impermeable, flexible contacting surface as opposed to traditional decorating tools that have rigid or inflexible tips.

In addition, the shaping tool 110 may include a solid interior support 114 made of metal or hard plastic and a sheath 116 overmolded or coated onto the support 114. The sheath 116 may be made from a food-grade silicone material and be ergonomically shaped. In one embodiment, the sheath 116 includes protuberances 118 that operate to enhance a user's grip on the tool 110 when the tool becomes wet or otherwise slippery. Alternatively, the shaping tool 110 may take the form of a unitary structure made of silicone or other food-safe material with a stiffness and/or durometer (if completely polymeric) sufficient for applying and manipulating the sugar-based substance.

The tips 112 may be integrally formed with the sheath to make the tool 110 appear seamless. In this way, the tool 110 may be easily cleaned, able to withstand high temperatures, and able to withstand a food sterilization process. Each of the shaping tools may have different shaped tips allowing for a variety of forming techniques to be applied. By way of example and as shown in FIG. 1, the shaping tools may be “double headed” with two different sized tips 112, of the same shape, on either end. However, a single shaping tool may include similar or different sized tips having similar or different shapes. Because the tips 112 of the shaping tool 110 are made from flexible silicone the tool can be used for applications where a traditional hard plastic, wood, or metal (i.e., rigid) tool would not produce the same result or have the same effect. In one embodiment, the shaping tools may be color coded for ease of identification based on the tool's stiffness (durometer) and/or application. Advantageously, the shaping tools may be configured with a seamless construction, food safe design and operational durability. Multiple sets of shaping tools having various sizes, shapes, and durometers may be made available as a kit for performing a variety of functions.

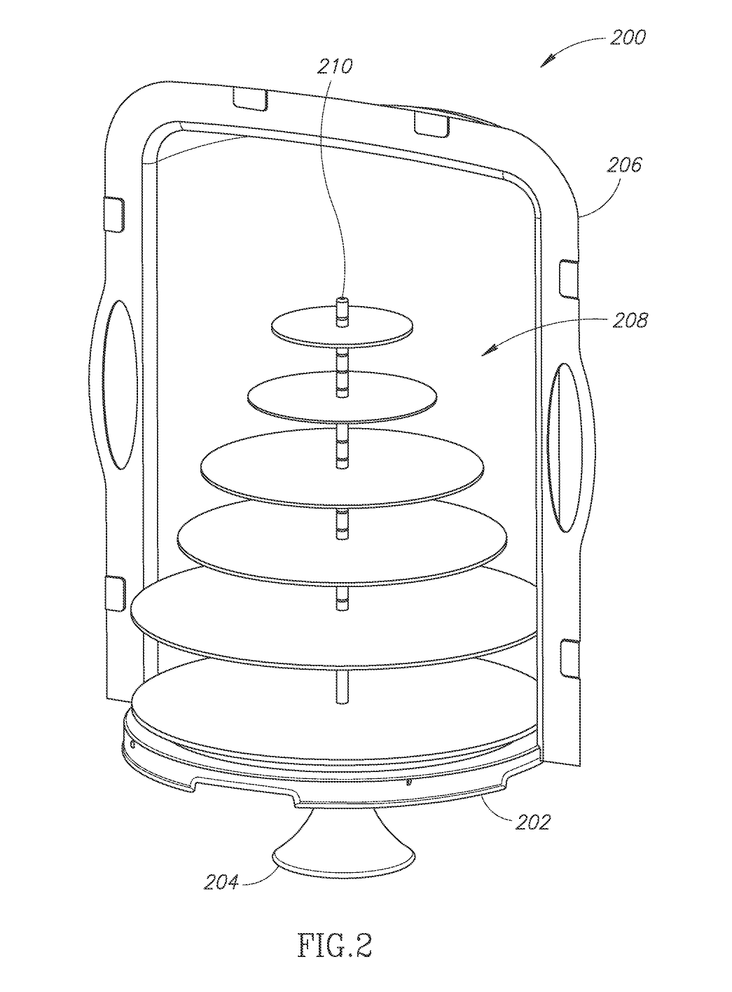

FIG. 2 shows a turntable system 200 according to another embodiment of the present invention. The turntable system 200 may provide a variety of advantages over conventional turntables. In the context of cake baking, a baker may be desirable for a larger, more spacious work platform or work surface. Conventional turntables are typically sized based on a desired size for a bottom cake tier with little, if any, additional, radial space. To create additional space, the baker typically has to resort to inaccurately sized and often unstable support around the radial edge of the turntable. Such supports may create centering issues as the cake is decorated and as other cake tiers are added. The absence of an accurately centered and stable work surface may disrupt the baker's points of reference during the decorating process. Aside from the baker's inherent frustration, the baker may also have to confront the loss of time and ingredients to correct the shape, which in turn decreases the baker's time to pursue new business.

Many conventional turntables simply take the forms of unmarked cake rounds (or other shapes) that often have sharp, unfinished edges. Such edges may generate cuts on the baker's hands when manipulating the turntable or rounds. If left unnoticed, such cuts may result in an unsanitary situation and pose a risk of cross-contamination since the baker is working with food consumables. Further, many conventional turntable lack handles or notches that would permit the turntable to be used as base during transportation. Once the user places a crude flat round on a turntable to extend their working surface, it becomes difficult to grasp and equally difficult to transport.

The turntable system 200 includes a turntable expander 202, a turntable base 204, a carrying handle 206, cake rounds 208, and a dowel 210. The turntable system 200, and in particular the turntable expander 202, may be utilized in baking, pastry and culinary applications or environments, and may also be utilized in other applications or environments where a work surface of a turntable needs to be enlarged or made bigger either temporarily or permanently. By way of example, the turntable expander 202 may be advantageously employed in commercial environments such as professional bakeries and kitchens to allow a more efficient and effective work surface for constructing and decorating food products.

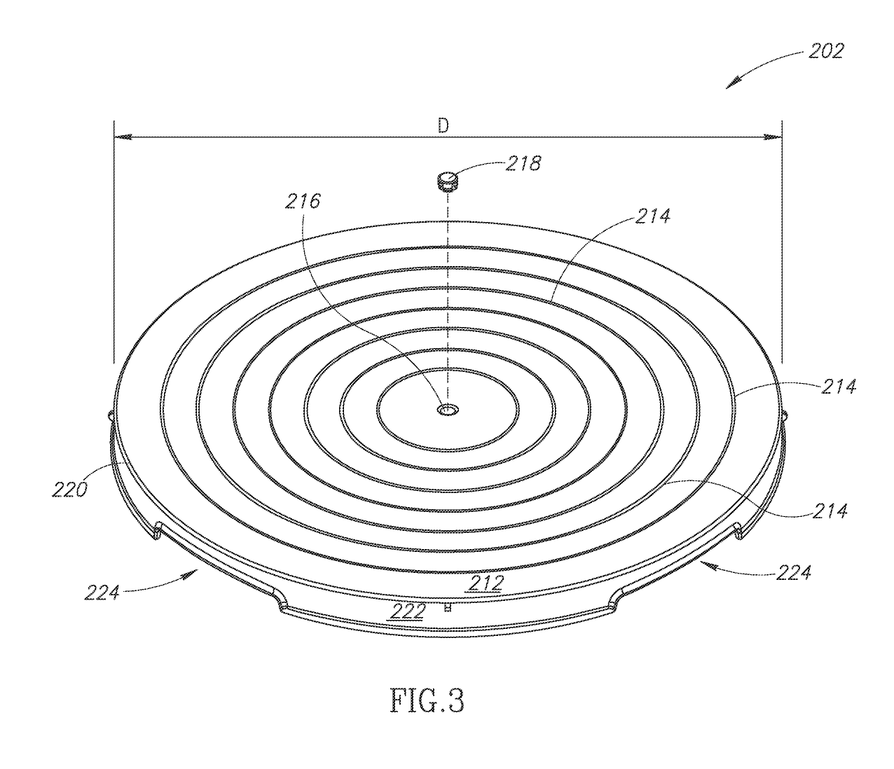

FIG. 3 shows the turntable expander 202, which may function as a durable food-grade molded plastic work surface, a transport base, and a storage platform. In the illustrated embodiment, the turntable expander 202 has a working surface with a circular shape having a diameter, D, which is generally larger than a base cake round. Preferably, an area of the working surface is substantially larger than a contact area of the product such that the diameter of the working surface extends at least one inch beyond the contact area of the product. For purposes of brevity, the description herein relates to a circular turntable expander 202, but it is understood that the turntable expander 202 may have other shapes such as, but not limited to, square, rectangular, oval, etc. As such, the other features discussed herein may take a shape that is complementary to the shape of the turntable expander 202.

An upper surface 212 may include a plurality of concentric, bars 214 that operate to center the cake rounds and provide traction for the base cake round or cake itself. The bars 214 may be integrally formed with the surface 212 or make take the form of a food-grade material attached to the surface 212. The bars may take the form of raised bars, textured bars, or polished bars. Optionally, the surface 212 may be coated or textured to minimize or increase friction depending on its intended application. The turntable expander 202 may optionally include a center aperture 216 configured to receive a variety of centering pins designed for specific needs (i.e., a nail-like shape for working on foam dummies, holds foam in place when speared by a centering “pin”, a circular shape designed to hold a cake round in place/centered, etc.).

A periphery 220 of the turntable expander 202 includes a circumferential sidewall 222 that extends downward from the surface 212. The sidewall 222 includes a plurality of handles 224 that, in one embodiment, take the form of recesses or undercuts formed in the sidewall 222. While the preferred embodiment takes the form of recessed handles 224, it is appreciated that other types of handles may be attached to or integrally formed with the turntable expander 202. Preferably, pairs of handles 224 are located diametrically opposed relative to the turntable expander 202 so that a two person team may lift the turntable expander 202 (e.g., supporting a decorated cake) in a balanced and uniform manner. The handles 224 permit the turntable expander 202 to function as a secure and stable transport base for finished or in-progress products. A gripping edge 226 of the handles may be coated with an overmolded material to reduce slippage while further being ergonomically shaped.

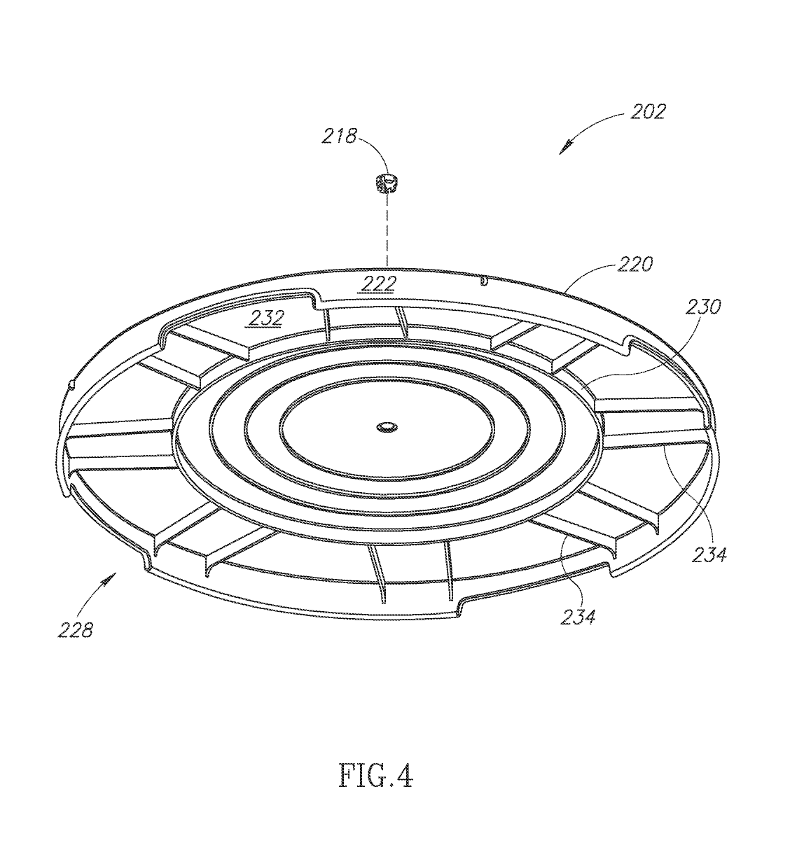

FIG. 4 shows an underside configuration 228 of the turntable expander 202. In the illustrated embodiment, the underside configuration 228 includes at least one circular support 230 concentric with the sidewall 222 and extending downward from a bottom surface 232 of the turntable expander 202. A plurality of radial supports 234 extend from the circular support 230 to the sidewall 222. The supports 230, 234 provide a desired amount of stiffness and strength to the turntable expander 202, especially when it is set on the turntable base 204 and loaded with product (FIG. 2) and/or when it is used to transport product.

The turntable expander 202 may be made from a single material and integrally formed or it may be made from multiple materials and assembled accordingly. In one embodiment, the turntable expander 202 is made from a molded plastic with silicone applied to prevent slippage and to provide a comfortable and ergonomic grip.

Advantageously, one purpose of the turntable expander 202 is to provide an artisan with a larger work surface than a conventional turntable. Another purpose of the turntable expander 202 is to operate as a storage and/or transportation platform when loaded with product.

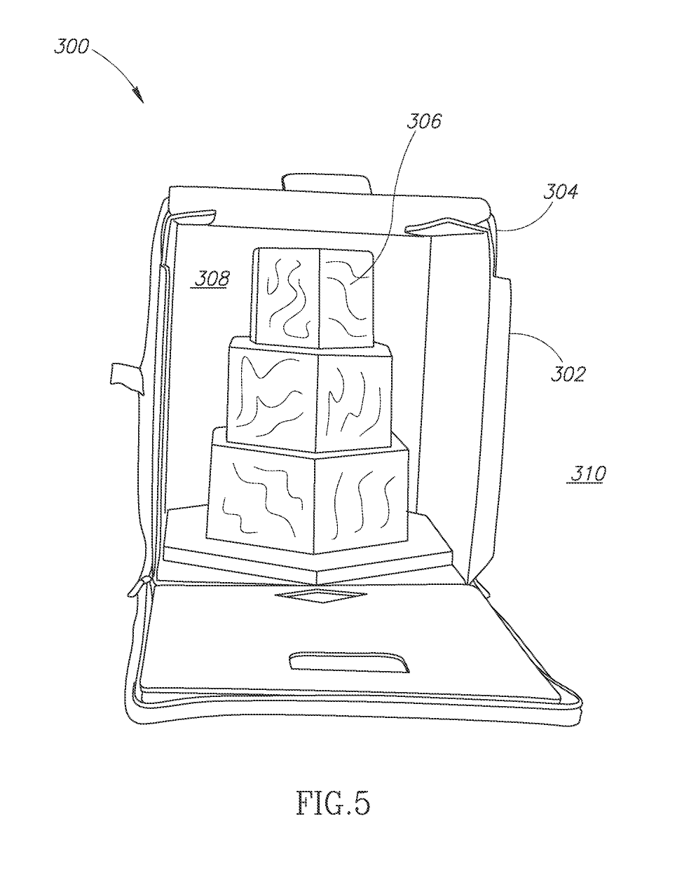

FIG. 5 shows a product transportation system 300 according to an embodiment of the present invention. In the cake baking industry, transporting a finished, decorated cake (e.g., a multi-tiered wedding cake) from the bakery to a customer has always been fraught with issues that that would not be recognized or even appreciated by those unfamiliar with the industry. Most commonly, decorated cakes are placed in a cardboard box for transportation because such boxes are inexpensive and may be left with the customer. Other transport systems are available, such as hard plastic boxes, but these are typically difficult to assemble, store, and they may about $200 to about $300, if not more.

Cardboard boxes, candidly, elicit an unprofessional presentation, are awkward to load, lift and carry, and sometimes may not be a suitable size (e.g., too short, not wide enough, etc.). Further, cardboard boxes are not necessarily cost effective, not reusable, and generally impractical in an overall sense. The plastic boxes currently available are not cost effective options for bakeries that transport multiple products on a daily basis and the inventory of the same typically takes up a large amount of space within the bakery.

One purpose of the product transportation system 300 is to provide the artisan in the bakery and culinary art fields with a secure, clean, reusable, convenient, and inexpensive vessel to preserve and transport product (e.g., cakes, sugar sculptures, chocolate displays, art projects, etc.). The product transportation system 300 may also be used for sculpture, pottery, painting, glasswork, or any other application in which delicate product needs to be covered and protected in transport. The product transportation system 300 may operate to protect products from outside contamination and temperatures. Additionally or alternatively, the product transportation system 300 may function as a storage device to protect showpieces and finished product from collecting dust and being damaged by sunlight or other environmental factors. The product transportation system 300 may be sized and configured to receive the turntable expander 202 loaded with product.

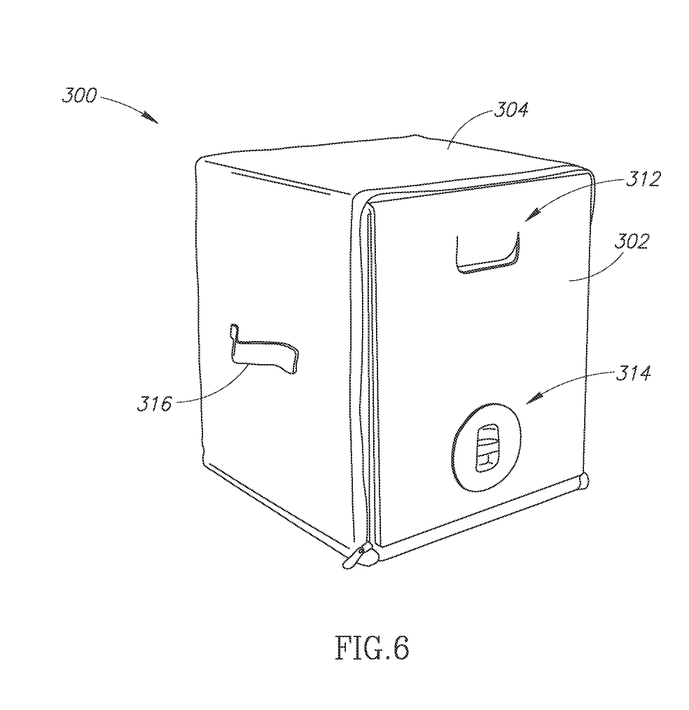

In one embodiment, the product transportation system 300 may take the form of a one-piece vessel 302 made of corrugated plastic that may be reusable or recyclable. The product transportation system 300 may alternatively be made from bio-plastic, wax coated cardboard, insulation board, or a more permanent food-safe plastic material. Optionally, the product transportation system 300 may include an insulator 304 sized to snugly receive the vessel 302. The insulator 304 may be configured to maintain the product 306 at a desired temperature by slowing a heat transfer rate between an interior 308 of the vessel and an ambient environment 310. FIG. 6 shows an embodiment of the product transportation system 300 in which the vessel 302 includes carrying handles 312 and a locking mechanism 314. Likewise, the insulator 304 may include one or more handles 316.

In the illustrated embodiment, the product transportation system 300 may take the form of a square shaped vessel or container. The product transportation system 300 may also take other non-square forms or shapes.

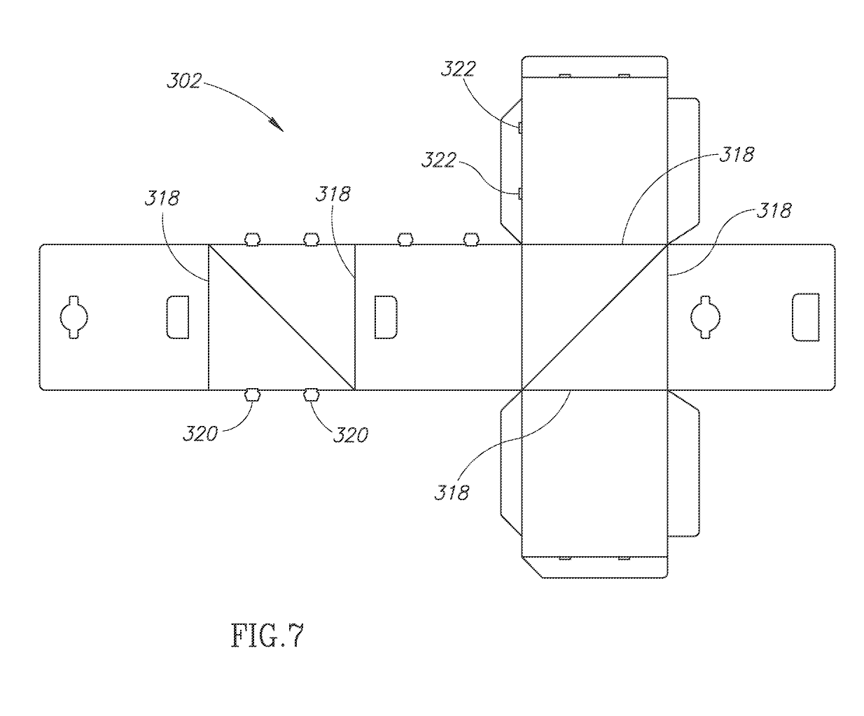

FIG. 7 shows a disassembled configuration of the vessel 302 according to an embodiment of the present invention. The vessel 302 is arranged in a planar manner such that the vessel 302 may be laid flat for storage purposes. In the illustrated embodiment, the various horizontal and/or vertical lines 318 indicate fold lines for assembly. The vessel 302 may include tabs 320 sized to engage with recesses 322 during assembly. In lieu of or in addition to the tabs 320 and recesses 322, other types of closures such as, but not limited to, locking mechanisms, VELCRO® fasteners, snaps, straps, latches, etc.

In one embodiment, an insulating wrap, cover or liner may be employed with product transportation system 300 to control the temperature and humidity level within the system 300 for at least a limited amount of time.

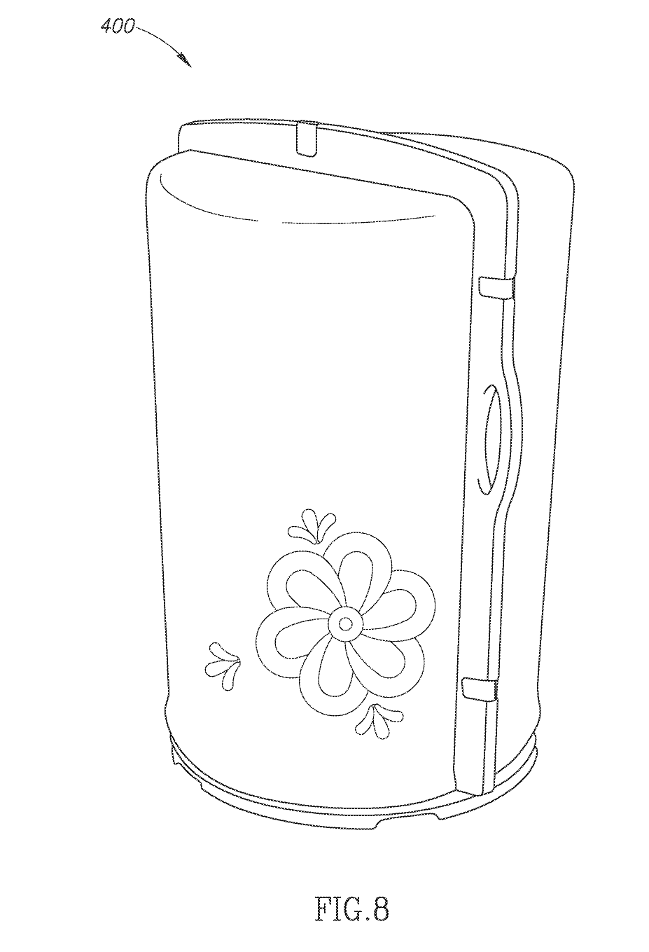

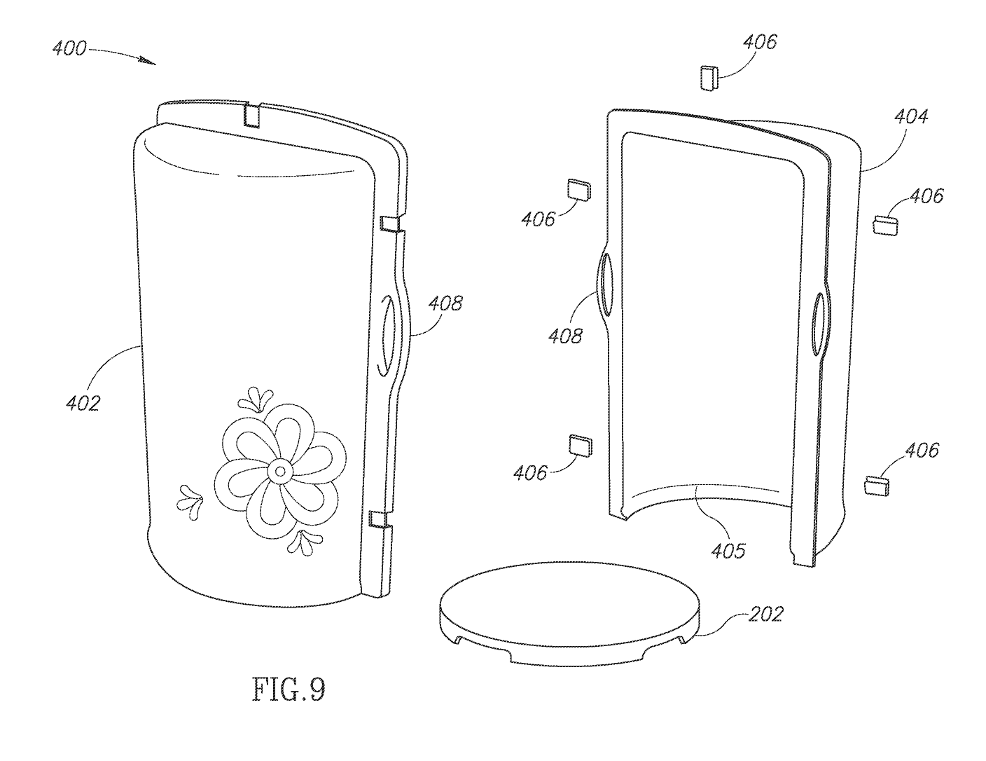

FIGS. 8 and 9 show a product transportation system 400 according to another embodiment of the present invention. As best shown in FIG. 8, the product transportation system 400 may take the form of two, connectable clam shell halves 402, 404, each having a shoulder 405 for supporting the turntable expander 202. The product transportation system 400 may further include assembly tabs or clips 406 and handles 408.

As part of an overall system, the product transportation system provides a professional container to transport or store product. The price point may eliminate time and money spent in retrieving a non-disposable or non-reusable vessel. In addition, the flat, foldable sheet or clam shell halves provide for easy storage in a relatively small space, thus freeing up inventory space in a bakery, for example.

The various embodiments described above can be combined to provide further embodiments. All of the above U.S. patents, patent applications and publications referred to in this specification are incorporated herein by reference. Aspects can be modified, if necessary, to employ devices, features, and concepts of the various patents, applications, and publications to provide yet further embodiments.

These and other changes can be made in light of the above detailed description. In general, in the following claims, the terms used should not be construed to limit the invention to the specific embodiments disclosed in the specification and the claims, but should be construed to include all types of tools, accessories, turntable systems, transportation systems, as well as other systems and processes in the baking and culinary fields that operate in accordance with the claims. Accordingly, the invention is not limited by the disclosure, but instead its scope is to be determined entirely by the following claims

1. A system for a baked product, the system comprising:
a shaping tool made from a food-grade material, the shaping tool having a main body with flexible tips coupled to the body, the flexible tips configured to manipulate a sugar-based substance in a desired manner;
a turntable having a working surface area that is substantially larger than a contact area of the baked product, the turntable having an upper surface configured to minimize lateral movement of the baked product, the turntable having at least one sidewall with handles; and
a transportation system having a vessel sized to receive the baked product.

2. The system of claim 1, further comprising a sheath overmolded onto the main body.

3. The system of claim 2, wherein the sheath includes a plurality of protuberances.

4. The system of claim 1, wherein the flexible tips have different durometers.

5. The system of claim 1, wherein the handles are recessed into the sidewall.

6. The system of claim 1, wherein the upper surface of the turntable includes a plurality of raised bars integrally formed with the surface.

7. The system of claim 1, further comprising an insulating cover sized to fit snugly onto the vessel.

8. The system of claim 1, wherein the vessel occupies a planar layout when disassembled.

9. A system for a baked product, the system comprising:
a shaping tool made from a food-grade material, the shaping tool having a main body with flexible tips coupled to the body, the flexible tips configured to manipulate a sugar-based substance in a desired manner;
a turntable having a working surface area that is substantially larger than a contact area of the baked product, the turntable having an upper surface configured to minimize lateral movement of the baked product, the turntable having at least one sidewall with handles; and
a transportation system having at least two parts connectable to each other, each part having a shoulder to support the turntable when the parts are connected.

10. The system of claim 9, further comprising a sheath overmolded onto the main body.

11. The system of claim 10, wherein the sheath includes a plurality of protuberances.

12. The system of claim 9, wherein the flexible tips have different durometers.

13. The system of claim 9, wherein the main body and the tips are integrally formed.

14. The system of claim 9, wherein the handles are recessed into the sidewall.

15. The system of claim 9, wherein the upper surface of the turntable includes a plurality of bars integrally formed with the surface.

16. The system of claim 9, further comprising a coating applied to the upper surface of the turntable.

17. The system of claim 9, wherein the at least two parts of the transportation system are clamshell-shaped parts.

18. A turntable for supporting a baked product, the turntable comprising:
an upper working surface having a working surface area that is substantially larger than a contact area of the baked product;
a sidewall extending from the upper working surface;
a plurality of recessed handles formed in the sidewall;
a bottom surface; and
a plurality of structural ribs extending downward from the bottom surface of the turntable.

19. The turntable of claim 18, further comprising a plurality of bars located on the upper working surface.

20. The turntable of claim 18, further comprising a non-stick texture coating applied to the upper working surface.

21. The turntable of claim 18, wherein the turntable includes an aperture extending through the upper working surface and the bottom surface.

22. The turntable of claim 18, wherein at least one of the plurality of structural ribs extends in a radial direction.

23. The turntable of claim 18, wherein at least one of the plurality of structural ribs extends in a circumferential direction.
